(19) United States
(12) Patent Application Publication
(10) Pub. No.: US 2010/0123550 A1
(43) Pub. Date: May 20, 2010

(54) Coaxial Antenna Connection

(76) Inventors: Carl DEGIOVINE, Shirley, NY (US); Rehan Jaffri, New York, NY (US); Carl Thelemann, East Islip, NY (US)

Correspondence Address: Fay Kaplun & Marcin, LLP/ Motorola, 150 Broadway Suite 702, New York, NY, 10038, US

(21) Appl. No.: 12/272,350

(22) Filed: Nov. 17, 2008

(51) Int. Cl. H04Q 5/22

(52) U.S. Cl. 340/10.1; 340/572.7

(57) ABSTRACT

A device comprises an RFID transceiver disposed on a first side of a printed circuit board; an antenna disposed on a second side of the printed circuit board; and a cable passing through the printed circuit board, a first end of the cable being connected to the RFID transceiver, a second end of the cable being connected to the antenna.

### BACKGROUND

Many modern mobile devices use radio-frequency identification (“RFID”) transceivers for wireless communication for various purposes. Like other types of wireless transceivers, RFID transceivers are typically connected to an antenna for transmitting and receiving signals. For optimal performance, the cable used to connect an RFID transceiver to its corresponding antenna should be as short as possible.

### SUMMARY OF THE INVENTION

The present invention relates to a device comprises an RFID transceiver disposed on a first side of a printed circuit board; an antenna disposed on a second side of the printed circuit board; and a cable passing through the printed circuit board, a first end of the cable being connected to the RFID transceiver, a second end of the cable being connected to the antenna.

### BRIEF DESCRIPTION OF THE DRAWINGS

FIG. 1 shows an exemplary mobile device according to the present invention.

FIG. 2 shows an exemplary cable assembly according to the present invention.

FIG. 3 shows an alternate view of the exemplary cable assembly of FIG. 2.

### DETAILED DESCRIPTION

The exemplary embodiments of the present invention may be further understood with reference to the following description and the appended drawings, wherein like elements are referred to with the same reference numerals. The exemplary embodiments describe mobile devices that minimize cable length and improve transceiver performance by routing a cable through a printed circuit board.

RFID is used by many mobile devices for various purposes, including identification, short-range communication, security/authentication, tracking/location, etc. An RFID subsystem may include an RFID transceiver (also referred to as a “tag”), an antenna to transmit and receive signals, a power source (e.g., a battery) for providing power to the transceiver, and a cable or series of cables for connecting the transceiver to the antenna. The cable may be, for example, a coaxial cable.

Mobile devices that employ RFID communication and include the above components, like most electronic devices, are typically built using one or more printed circuit boards (“PCB”). A PCB is used to support and electrically connect various components using conductive pathways etched into a non-conductive substrate. The PCB may be fixed with respect to a casing of a device, and other components may be fixed with respect to the PCB.

Because space is limited in mobile devices, components of a certain size or type may need to be located in a particular position within the device. For example, an antenna may be located near the exterior of a device in order to improve performance. Further, because of these space concerns, components that must be electrically coupled to one another may not necessarily be able to be located in close physical proximity to one another. In some situations, these spatial concerns may lead to electrically connected components being disposed on opposite sides of a PCB from one another. Commonly, these components may be the RFID transceiver and its corresponding antenna, as discussed above. Despite such placement remotely from one another, the cable used to connect a transceiver and its corresponding antenna is preferably as short as possible in order to prevent signal degradation.

Previously, such components have been electrically coupled to one another in one of two ways. In the first, a hole may be placed in the PCB and the cable may be routed through the hole. Alternately, the cable may be wrapped around the edge of the PCB. However, both of these methods have disadvantages. First, in either case, the cable must be tied down and contained with precision. If the cable position varies from one product to the next, the performance may vary correspondingly, such as due to interference from nearby components; such variability is undesirable. Second, placing a hole in the PCB adds complexity to the manufacturing process. Third, wrapping the cable around the PCB requires a longer cable, which is undesirable as described above.

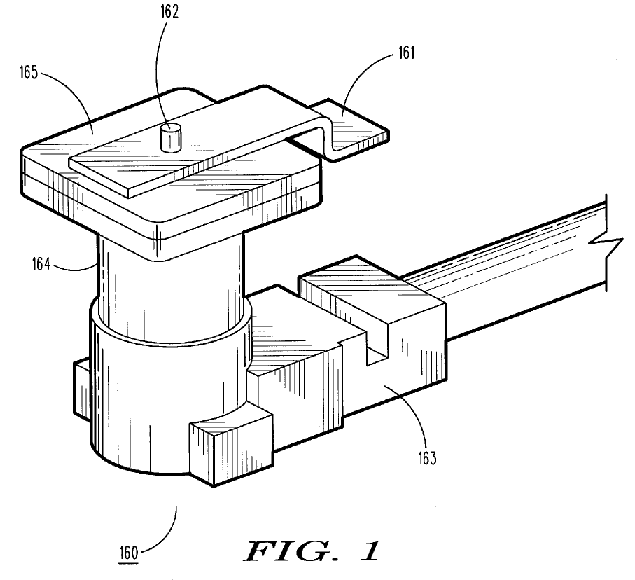

The exemplary embodiments described herein thus avoid these issues by using a connection to send the signal through the PCB. FIG. 1 illustrates a schematic view of an exemplary device 100. Those of skill in the art will understand that the device 100 may include various components other than those shown here in describing the exemplary embodiments. The device 100 includes a PCB 110 that may provide a physical mounting point for various components as well as electrical connections as described above. Mounted to the PCB 110 is an RFID transceiver 120, which may serve any of the various purposes described above as well as others not listed. The PCB 110 provides a structural location for the RFID transceiver 120 and also serves to connect the RFID transceiver 120 electrically to other components as will be described herein.

The device 100 includes a power source 130 (e.g., a disposable or rechargeable battery, line power, etc.) supplying power to the RFID transceiver 120 and other components of the device 100. The power source 130 may be physically mounted to the PCB 110 or located elsewhere, but electrical connections to the power source 130 are typically accomplished via the PCB 110. The device 100 further includes a signal source 140 (e.g., a processor, etc.) that may handle data communications with the RFID transceiver 120; those of skill in the art will understand that the signal source 140 may also perform other tasks. As for the power source 130, the signal source 140 may be attached to the PCB 110 or located elsewhere, but its electrical connections are accomplished via the PCB 110.

The RFID transceiver 120 accomplishes its wireless communication by means of an antenna 150. The antenna 150 may be of any type suitable for performing this communication. The RFID transceiver 120 is connected to the antenna 150 by means of an antenna cable assembly 160, which will be discussed in more detail below. The antenna cable assembly 160 is typically a coaxial cable including an inner conductor for carrying a signal and an outer conductor for providing electromagnetic shielding, separated from one another by an insulating layer. With the exception of the antenna 150, all components of the device 100 are typically located within a housing 170; the antenna may optionally be located outside the housing, partially within and partially without, or be integrated with the housing.

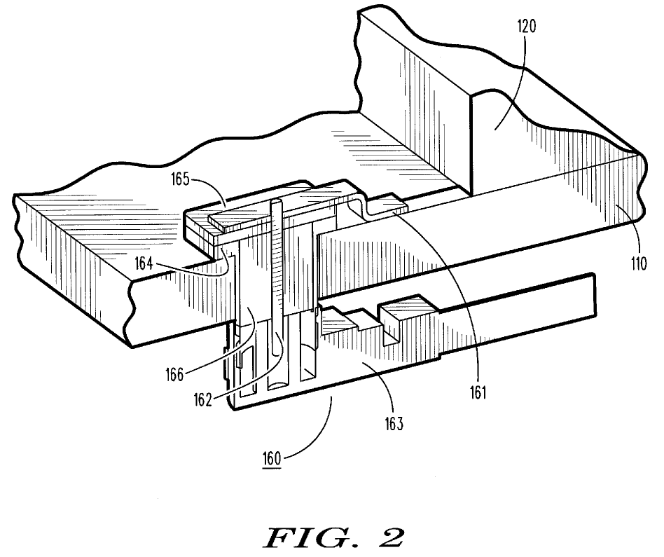

FIG. 2 shows an enlarged cutaway view of an exemplary antenna cable assembly 160 (also referred to herein as “assembly 160”). The assembly 160 includes a center lead 161 (e.g., the inner conductor of the coaxial cable) conveying a signal to and from the RFID transceiver 120. The center lead 161 is typically connected to the RFID transceiver 120 by a soldered connection. The center lead 161 joins a center pin 162, which runs through the PCB 110 and carries the same signal as the center lead 161. The center pin 162 then joins the center conductor of a coaxial cable assembly 163 that is disposed on the same side of the PCB 110 as the antenna 150, which connects to the antenna 150 and completes the signal pathway. The coaxial cable assembly 163 may be, for example, a standard L-shaped coaxial cable terminator attached to a coaxial cable.

The center pin 162 is shielded by an outer shell 164 in the manner described above with reference to the outer conductor of a typical coaxial cable. The outer shell 164 is mounted in a plated hole in the PCB 110, preferably by soldering, and is thus grounded and shields the signal in the center pin 162. In one exemplary embodiment, the outer shell 164 may be a MIL-STD-348A plug; in another, it may be a 50 ohm U.FL connector. The center lead 161 and the center pin 162 are separated from the outer shell by insulators 165 and 166, which may be made from plastic or any other suitable insulating material. In other embodiments, insulators 165 and 166 may be formed as a single part. The insulator 166 joins the insulator (not shown) of the coaxial cable assembly 163, insuring full signal isolation. It should be noted that the illustration of the coaxial cable assembly 163 in FIG. 2 is truncated for clarity and that the assembly 163 extends sufficiently far to connect to the antenna 150.

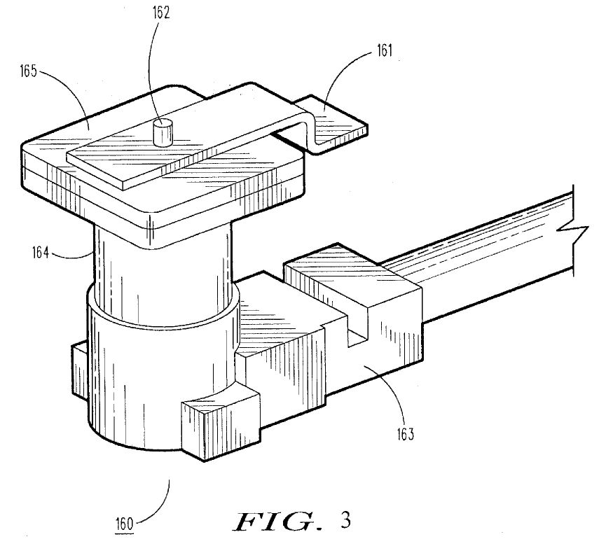

FIG. 3 shows an alternate view of the exemplary antenna cable assembly 160, omitting the PCB 110 for clarity. As can be seen, the signal-carrying center pin 162 is shielded while it passes through the PCB 110 in order to avoid signal interference or unwanted electrical contacts. As stated above, the coaxial cable assembly 163 may extend away from the antenna cable assembly 160 to join antenna 150 (not shown in FIG. 3). The insulator 165 is shown as conforming to the profile of the upper portion of the outer shell 164; however, those of skill in the art will understand that the precise shape of the insulator 165 may vary, and that other profiles that are still sufficient to insulate the center lead 161 from the outer shell 164 are also possible. In one such alternative embodiment, the insulator 165 may completely cover the upper portion of the outer shell 164 and contact the PCB 110 on all sides. Further, though the center pin 162 is shown as projecting above the center lead 161, in other embodiments the top of the center pin 162 may be flush with the center lead 161; alternately, the center pin 162 may be formed integrally with the center lead 161.

Thus, in the above-described exemplary embodiments, the antenna cable is restrained in a fixed position in order to achieve constant, predictable performance. Further, the length of cable required to connect a transceiver on one side of a PCB to an antenna on the other side may be minimized. Additionally, the cable may be shielded from interference while it passes through the PCB.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A device, comprising:
an RFID transceiver disposed on a first side of a printed circuit board;
an antenna disposed on a second side of the printed circuit board; and
a cable passing through the printed circuit board, a first end of the cable being connected to the RFID transceiver, a second end of the cable being connected to the antenna.

2. The device of claim 1, wherein the cable is a coaxial cable.

3. The device of claim 1, wherein the cable passes through the printed circuit board via a connector.

4. The device of claim 3, wherein the connector is a MIL-STD-348A plug.

5. The device of claim 3, wherein the connector is a 50 ohm U.FL connector.

6. The device of claim 3, wherein the connector is soldered to the printed circuit board.

7. The device of claim 1, wherein the antenna is disposed inside a housing of the device.

8. The device of claim 1, wherein the cable connects to the RFID transceiver by means of a trace.

9. The device of claim 3, further comprising:
an insulator disposed within the connector.

10. The device of claim 9, further comprising:
a further insulator disposed on a first end of the connector, the first end of the connector located on the first side of the printed circuit board.

11. A method for manufacturing a mobile device, comprising:
locating an RFID transceiver on a first side of a printed circuit board;
locating an antenna on a second side of the printed circuit board; and
connecting the RFID transceiver to the antenna using a cable that passes through the printed circuit board.

12. The method of claim 11, wherein the cable is a coaxial cable.

13. The method of claim 11, wherein the cable passes through the printed circuit board via a connector.

14. The method of claim 13, wherein the connector is a MIL-STD-348A plug.

15. The method of claim 13, wherein the connector is a 50 ohm U.FL connector.

16. The method of claim 13, wherein the connector is soldered to the printed circuit board.

17. The method of claim 11, wherein the antenna is disposed inside a housing of the device.

18. The method of claim 11, wherein the cable connects to the RFID transceiver by means of a trace.

19. The method of claim 13, further comprising:
installing an insulator within the connector.

20. The method of claim 19, further comprising:
installing a further insulator on a first end of the connector, the first end of the connector located on the first side of the printed circuit board.
